(19) United States
(12) Patent Application Publication
(10) Pub. No.: US 2017/0353961 A1
(43) Pub. Date: Dec. 7, 2017

(54) Managing Radio Utilization of an Access Point

(71) Applicant: QUALCOMM Incorporated, San Diego, CA (US)

(72) Inventors: An He, San Jose, CA (US); Brian Michael Buesker, San Diego, CA (US); Xuetao Chen, Fremont, CA (US); Andrew Friefeld, Scotts Valley, CA (US); Eyal Hochdorf, Palo Alto, CA (US)

(21) Appl. No.: 15/172,325

(22) Filed: Jun. 3, 2016

(51) Int. Cl. H04W 72/04; H04W 28/02; H04W 72/08

(52) U.S. Cl. CPC H04W 72/0486; H04W 72/085; H04W 28/0236; H04W 72/048; H04W 72/082

(57) ABSTRACT

Various embodiments include systems and methods for managing radio utilization by a processor of a wireless access point. In response to receiving an access request from a wireless station, the processor may determine whether a multi-user (MU) physical layer quality of a communication link between a radio of the access point and the wireless station exceeds a quality threshold. The processor may determine whether a load of the radio of the access point is below a load threshold in response to determining that the MU physical layer quality of the communication link exceeds the quality threshold. The processor may associate the wireless station with the radio of the access point in response to determining that the load of the radio of the access point is below the load threshold. The processor may monitor established communication links to determine whether a change in association of radios with wireless stations is appropriate.

### BACKGROUND

Wireless networks are widely deployed, especially for use in relatively well-defined areas such as residences, workplaces, and certain public venues. A wireless access point can be connected to an Ethernet network, a cable modem, or a digital subscriber line modem to provide wireless access to a broadband network. A wireless station (e.g., a smart phone, a tablet, a laptop, or another similar device) may establish a communication link (“associate”) with an access point, either directly or through a range extender device.

To increase the bandwidth available to wireless stations, access points may be configured with an increasing number of radios capable of transmitting and receiving signals in a variety of frequency bands. For example, a three-radio access point may be configured to support simultaneous communications on three channels. Three-radio operations may be enabled by communication protocols such as the Institute of Electrical and Electronic Engineers (IEEE) 802.11ac communication protocols. 802.11ac also provides for multi-user multiple-input multiple-output (MU-MIMO) operation, which supports simultaneous multi-stream communication from the access point to multiple wireless stations. MU-MIMO operations may thus substantially improve wireless communications with the access point.

Balancing access among radios of the access point as a part of MU-MIMO operations may increase available capacity and throughput of the radio bandwidth of the access point.

### SUMMARY

The various embodiments include methods and access points implementing methods for managing radio utilization of an access point. Various methods may include determining whether a multi-user (MU) physical layer quality of a communication link between a radio of the access point and a wireless station exceeds a quality threshold in response to receiving at the access point an access request from the wireless station. Such embodiments may further include determining whether a load of the radio of the access point is below a load threshold in response to determining that the MU physical layer quality of the communication link exceeds the quality threshold. Such embodiments may further include associating the wireless station with the radio of the access point in response to determining that the load of the radio of the access point is below the load threshold.

In some embodiments, determining whether the load of the radio of the access point is below the load threshold may include determining whether an overall load of the radio is below an overall load threshold, and associating the wireless station with the radio of the access point may include associating the wireless station with the radio in response to determining that the overall load of the radio is below the overall load threshold.

In some embodiments, determining whether the load of the radio of the access point is below the load threshold may include determining whether an MU load of the radio is below an MU load threshold, and associating the wireless station with the radio of the access point may include associating the wireless station with the radio in response to determining that the MU load of the radio is below the multi-user load threshold.

The various embodiments may include methods for managing radio utilization of an access point, which may include determining whether a load of a first radio of the access point is below a load threshold, in which one or more wireless stations are associated with the first radio. Such embodiments may further include selecting a wireless station associated with the first radio in response to determining that the load is below the load threshold. Such embodiments may further include determining whether a multi-user (MU) physical layer quality of a communication link between the first radio of the access point and the selected wireless station exceeds a quality threshold. Such embodiments may further include associating the selected wireless station with a second radio of the access point in response to determining that the MU physical layer quality of the communication link between the first radio of the access point and the selected wireless station does not exceed the quality threshold.

In some embodiments, associating the selected wireless station with the second radio of the access may include determining whether an MU physical layer quality of a second communication link between the second radio and the wireless station exceeds the quality threshold, and associating the selected wireless station with the second radio in response to determining that the MU physical layer quality exceeds the quality threshold. Such embodiments may further include determining whether an overall load of the second radio is below an overall load threshold in response to determining that the MU physical layer quality of the second communication link exceeds the quality threshold, and associating the selected wireless station with the second radio in response to determining that the overall load of the second radio is below the overall load threshold. Some embodiments may further include determining whether an MU load of the second radio is below an MU load threshold in response to determining that the overall load of the second radio is below the overall load threshold, and associating the selected wireless station with the second radio in response to determining that the MU load of the second radio is below the MU load threshold.

In some embodiments, determining whether the load of the first radio of the access point is below the load threshold may include determining whether an overall load of the first radio is below an overall load threshold. Such embodiments may further include associating the selected wireless station with the second radio of the access point in response to determining whether an MU load of the first radio is greater than an MU load threshold in response to determining that the overall load of the first radio is not below the overall load threshold, and associating the selected wireless station with the second radio of the access point in response to determining that the MU load of the first radio is greater than the MU load threshold.

Some embodiments may further include determining a contribution of wireless stations associated with the first radio and operating in an MU mode to the overall load of the first radio in response to determining that the MU load of the first radio is not greater than an MU load threshold. Such embodiments may further include determining whether the contribution of the associated wireless stations operating in the MU mode to the overall load of the first radio exceeds a threshold contribution. Such embodiments may further include associating one of the wireless stations that is associated with the first radio with the second radio of the access point in response to determining that the contribution of the associated wireless stations operating in the MU mode to the overall load of the first radio exceeds the threshold contribution.

In some embodiments, determining whether the load of the first radio of the access point is below the load threshold may include determining whether an MU load of the first radio is below an MU load threshold. In such embodiments, associating the selected wireless station with the second radio of the access point may include determining whether an MU physical layer quality of a second communication link between the second radio and the selected wireless station exceeds a quality threshold, determining whether a load of the second radio is below a load threshold in response to determining that the MU physical layer quality of the second communication link exceeds the quality threshold, and associating the selected wireless station with the second radio in response to determining that the load of the second radio is below the load threshold. In such embodiments, determining whether the load of the second radio is below the load threshold may include determining whether an overall load of the second radio is below an overall load threshold. Such embodiments may further include associating the selected wireless station with the second radio in response to determining that the overall load of the second radio is below the overall load threshold. In such embodiments, determining whether the load of the second radio is below the load threshold may include determining whether an MU load of the second radio is below an MU load threshold. Such embodiments may further include associating the selected wireless station with the second radio in response to determining that the MU load of the second radio of the access point is below the multi-user load threshold.

Some embodiments may further include determining whether an MU data quality metric of the communication link exceeds a data quality threshold in response to determining that the MU physical layer quality of the communication link exceeds the quality threshold. Such embodiments may further include associating the selected wireless station with the second radio of the access point in response to determining that the MU data quality metric of the communication link does not exceed the data quality threshold. In some embodiments, associating the selected wireless station with the second radio of the access point in response to determining that the MU data quality metric of the communication link does not exceed the data quality threshold may include determining whether an MU physical layer quality of a second communication link between the second radio and the wireless station exceeds the quality threshold, and associating the selected wireless station with the second radio in response to determining that the MU physical layer quality exceeds the quality threshold.

Some embodiments may further include determining whether an overall load of the second radio is below an overall load threshold in response to determining that the MU physical layer quality of the second communication link between the second radio and the wireless station exceeds the quality threshold. Such embodiments may further include associating the selected wireless station with the second radio in response to determining that the overall load of the second radio is below the overall load threshold.

Some embodiments may further include determining whether an MU load of the second radio is below an MU load threshold in response to determining that the overall load of the second radio is below the overall load threshold. Such embodiments may further include associating the selected wireless station with the second radio in response to determining that the MU load of the second radio is below the MU load threshold.

Some embodiments may further include determining whether an MU interference of the communication link is below an MU interference threshold in response to determining that the MU data quality metric of the communication link exceeds the data quality threshold. Such embodiments may further include associating the selected wireless station with the second radio of the access point in response to determining that the MU interference of the communication link is not below the MU interference threshold.

In some embodiments, associating the selected wireless station with the second radio of the access point in response to determining that the MU interference of the communication link is not below the MU interference threshold may include determining whether an MU physical layer quality of a second communication link between the second radio and the selected wireless station exceeds the quality threshold, and associating the selected wireless station with the second radio in response to determining that the MU physical layer quality exceeds the quality threshold.

Some embodiments may further include determining whether an overall load of the second radio is below an overall load threshold in response to determining that the MU physical layer quality of the second communication link between the second radio and the selected wireless station exceeds the quality threshold. Such embodiments may further include associating the selected wireless station with the second radio in response to determining that the overall load of the second radio is below the overall load threshold.

Some embodiments may further include determining whether an MU load of the second radio is below an MU load threshold in response to determining that the overall load of the second radio is below the overall load threshold. Such embodiments may further include associating the selected wireless station with the second radio in response to determining that the MU load of the second radio is below the MU load threshold.

Various embodiments further include an access point having one or more radios, a memory, and a processor coupled to the one or more radios and the memory and configured with processor executable instructions to perform operations of the methods summarized above. Various embodiments include a non-transitory processor-readable storage medium having stored thereon processor-executable instructions configured to cause a processor of an access point to perform operations of the methods summarized above. Various embodiments include an access point having means for performing functions of the methods summarized above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of various embodiments.

FIG. 1 is a communication system block diagram of a communication system suitable for use with various embodiments.

FIGS. 2A and 2B are component block diagrams illustrating access points suitable for use with various embodiments.

FIGS. 2C and 2D are component block diagrams illustrating range extenders suitable for use with various embodiments.

FIG. 3 is a process flow diagram illustrating a method for managing radio utilization of a multi-radio access point according to various embodiments.

FIG. 4 is a process flow diagram illustrating a method for managing radio utilization of a multi-radio access point according to various embodiments.

FIG. 5 is a process flow diagram illustrating a method for managing radio utilization of a multi-radio access point according to various embodiments.

FIG. 6 is a process flow diagram illustrating a method for managing radio utilization of a multi-radio access point according to various embodiments.

FIG. 7 is a process flow diagram illustrating a method for managing radio utilization of a multi-radio access point according to various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of various embodiments or the claims.

Various embodiments provide methods for managing radio resource usage by a multi-radio wireless access point based on characteristics of a wireless communication link and the network performance of the access point and one or more wireless stations communicating with the access point.

The term “wireless station” is used herein to refer to a device that may associate with an access point, and includes any one or all of a cellular telephones, smart phones, personal or mobile multi-media players, personal data assistants (PDAs), laptop computers, tablet computers, smart books, palm-top computers, wireless electronic mail receivers, multimedia Internet enabled cellular telephones, wireless gaming controllers, and similar personal electronic devices that include a programmable processor, memory and circuitry for establishing wireless communication pathways and transmitting/receiving data via wireless communication pathways.

The term “access point” is used herein to refer to a device that may provide one or more wireless stations with a wireless communication link to a network connection via one or more radios, and includes wireless routers, range extenders, hotspot devices, and other similar devices. Thus, an access point may support a wireless communication link to a wireless station via a radio and may include circuitry for relaying network message traffic both directions between the wireless communication link and another network, such as a network connection to an Internet service provider (ISP) or a wired local area network.

The terms “component,” “unit,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having processor-executable instructions and/or data structures stored thereon. Components may communicate by way of local and/or remote processes, function or procedure calls, electronic signals, data packets, memory read/writes, and other known computer, processor, and/or process related communication methodologies.

Wireless access points may be configured with a plurality of radios capable of transmitting and receiving signals in a variety of frequency bands. For example, a three-radio access point may be configured to support simultaneous communications on three channels defined by three frequency bands. Such access points may also be configured to use one or more communication protocols that support simultaneous multi-channel communications, such as 802.11ac, which provides for MU-MIMO operation. Balancing access among radios of the access point for MU-MIMO operation can maximize available capacity and throughput of the access point's radio bandwidth.

Various embodiments and implementations provide methods implemented by a processor of a wireless access point to manage radio utilization of a multi-radio access point by performing proactive and responsive steering of wireless stations to radios of the access point.

In some implementations, when a wireless station requests access to an access point, the access point may determine whether a multi-user (MU) physical layer quality of a communication link between a selected radio of the access point and the wireless station exceeds a quality threshold. The quality threshold may be a quality measure at which the MU physical layer quality is sufficient to support MU communication between the access point and the wireless station using the selected radio of the access point. In response to determining that the MU physical layer quality of the communication link exceeds the quality threshold, the access point may determine whether a load of the radio of the access point is below a load threshold. In response to determining that the load of the radio of the access point is below the load threshold, the access point may associate the wireless station with the radio of the access point. In some implementations, the load of the radio may include an overall load (e.g., a traffic load) of the selected radio. In some implementations, the load of the radio may include an MU load (i.e., a traffic load attributable to MU communication) of the selected radio.

In some implementations, in response to determining that the MU physical layer quality of the communication link is below the quality threshold, or that the load of the radio is above the load threshold, the access point may select another radio of the access point and analyze the MU physical layer quality of a communication link between the newly selected radio and the wireless station, as well as the load of newly selected radio.

In some implementations, the access point may monitor communication performance and network performance of the access point with the associated wireless station, and may dynamically adjust the association of the wireless station with one or more radios of the access point.

For example, when the access point determines that the MU physical layer quality of the communication link drops below (or no longer exceeds) the quality threshold, the access point may associate a wireless station with a second radio of the access point. The access point may then determine whether an MU physical layer quality of a second communication link between the second radio of the access point and the wireless station exceeds the quality threshold. The access point may also determine whether a load of the second radio of the access point is below the load threshold. The load of the second radio may include one or more of an overall load of the second radio and an MU load of the second radio. The access point may associate the wireless station with the second MU-capable radio of the access point when the MU physical layer quality and the load of the second MU-capable radio permit.

In some implementations, the access point may associate the wireless station with a second radio of the access point in response to determining that an MU data quality metric of the communication link is less than a data quality threshold. Further, the access point may associate the wireless station with a second radio of the access point in response to determining that an MU interference of the communication link exceeds an MU interference threshold. In either of such situations, the access point may determine whether an MU physical layer quality of a second communication link between the second radio of the access point and the wireless station exceeds the quality threshold. The access point may also determine whether a load of the second radio of the access point is below the load threshold. The load of the second radio may include one or more of an overall load of the second radio and an MU load of the second radio. In such implementations, the access point may associate the wireless station with the second MU-capable radio of the access point when the MU physical layer quality and the load of the second MU-capable radio permit.

In some implementations, the access point may associate the wireless station with a second radio of the access point in response to determining that the overall load of the radio of the access point exceeds an overall load threshold. In such implementations, the processor of the access point may determine whether an MU load of the radio of the access point exceeds an MU load threshold. The access point may also determine a contribution of each wireless station associated with the selected MU-capable radio to the overall load of the selected MU-capable radio. In such implementations, the access point may determine whether an MU load of the second radio of the access point (i.e., a load contribution attributable to associated wireless stations that are operating in an MU mode) is below the MU load threshold.

In some implementations, the access point may associate the wireless station with a second radio of the access point in response to determining that an MU load of the radio of the access point exceeds the MU load threshold. The access point may determine whether an MU physical layer quality of a second communication link between the second radio of the access point and the wireless station exceeds the quality threshold. The access point may determine whether a load of the second radio of the access point is below the load threshold in response to determining that the MU physical layer quality of the second communication link exceeds the quality threshold.

By implementing various embodiments, a wireless access point may manage radio utilization by proactively and responsively monitoring and managing the association of one or more wireless stations to radios of the access point.

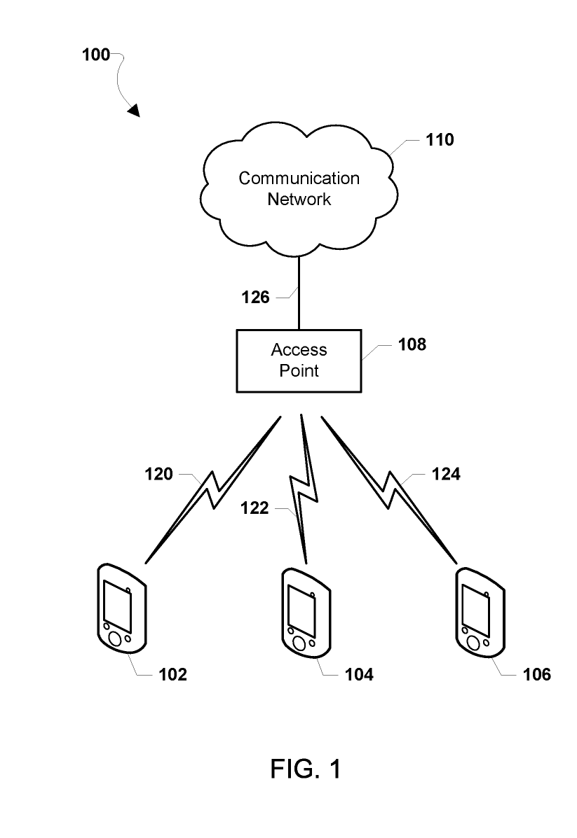

FIG. 1 illustrates a communication system 100 suitable for use with various embodiments. Wireless stations 102, 104, 106 may associate with a radio of an access point 108, and may communicate with the access point 108 through communication links 120, 122, and 124, respectively. The access point 108 may communicate with a communication network 110 over a wired or wireless communication link 126, which may include twisted-pair backhaul links, fiber optic backhaul links, microwave backhaul links, cellular data networks, and other suitable communication links. In some embodiments, the access point 108 may include a first access point and a second access point. For example, a first access point may communicate with the communication network 110, and a second access point may communicate with the first access point via a wired or wireless communication link. The second access point may also communicate with one or more wireless stations (e.g., the wireless stations 102, 104, 106), and thus the second access point may act as a range extender in communication with the first access point. In such embodiments, the first access point may also communicate with one or more wireless stations.

While the communication links 120, 122, 124 are illustrated as single links, each of the communication links 120, 122, 124 may include a plurality of carrier signals, frequencies, or frequency bands, each of which may include a plurality of logical channels. Additionally, each of the communication links 120, 122, 124 may utilize more than one radio access technology (RAT). In some embodiments, the communication links 120, 122, 124 may use a relatively short-range wireless communication protocol, such as Wi-Fi, ZigBee, Bluetooth, and others. The communication links 120, 122, 124 may include cellular communication links using 3GPP Long Term Evolution (LTE), Global System for Mobility (GSM), Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies. Additionally, each of the communication links 120, 122, 124 may utilize more than one radio access technology.

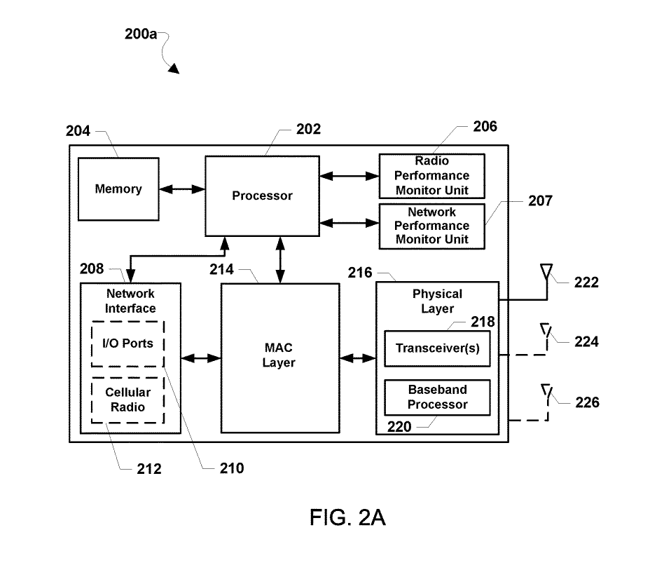

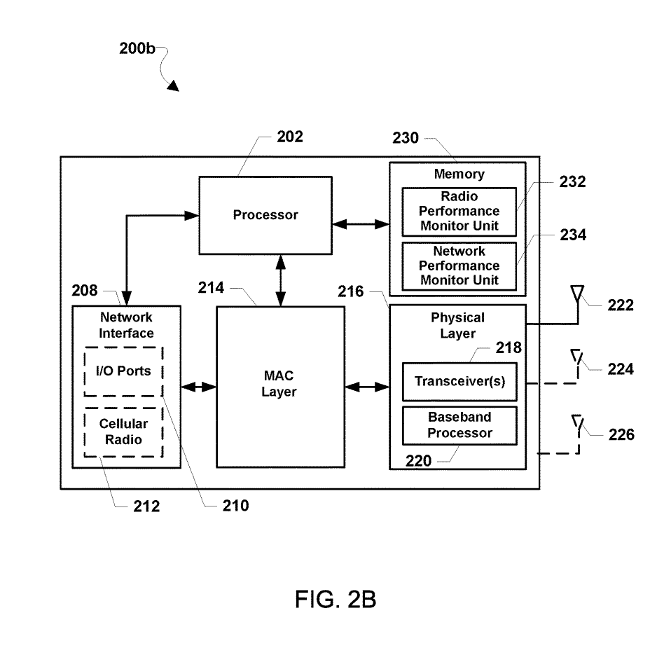

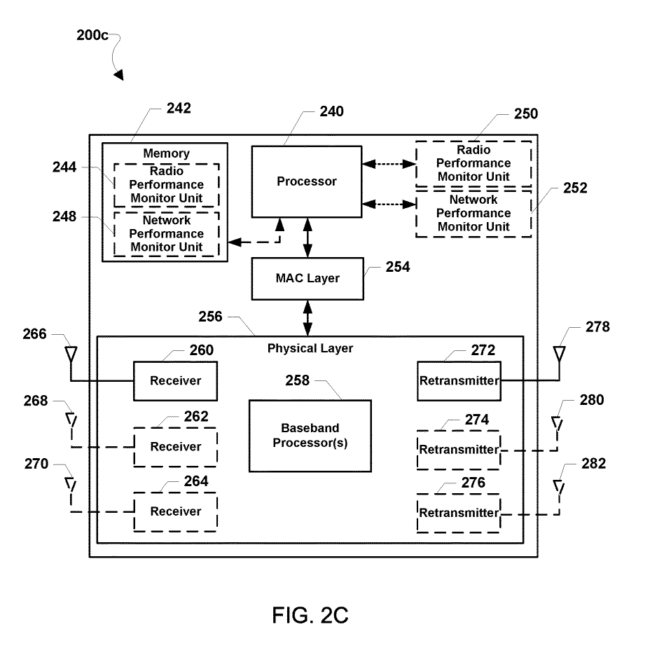

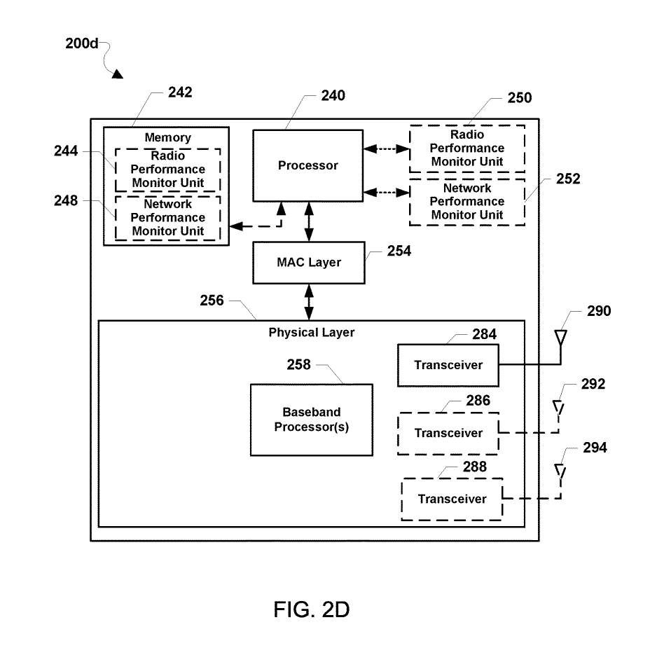

FIG. 2A is a component block diagram of an example of a wireless access point 200a suitable for implementing various embodiments. The access point 200a may be similar to the access point 108 in FIG. 1.

The access point 200a may include at least one processor 202. The processor 202 may be configurable with processor-executable instructions to execute operations of the various embodiments, a specialized processor (e.g., a modem processor) configurable with processor-executable instructions to execute operations of the various embodiments in addition to a primary function, dedicated hardware (e.g., “firmware”) circuit or circuits configured to perform operations of the various embodiments, or a combination of dedicated hardware/firmware and one or more programmable processors. For ease of reference, the various alternative configurations of hardware and programmed processor(s) are referred to generally in the description of the various embodiments as a “processor” 202.

The processor 202 may be coupled to memory 204, which may be a non-transitory computer-readable storage medium that stores processor-executable instructions as well as data. The memory 204 may store an operating system, as well as user application software and executable instructions implementing various embodiments. The memory 204 may also store application data, such as an array data structure. The memory 204 may include one or more caches, read only memory (ROM), random access memory (RAM), electrically erasable programmable ROM (EEPROM), static RAM (SRAM), dynamic RAM (DRAM), and/or other types of memory. The processor 202 may read and write information to and from the memory 204. The memory 204 may also store instructions associated with one or more protocol stacks. A protocol stack generally includes computer executable instructions to enable communications using a radio access protocol or communication protocol.

The access point 200a may also include a network interface 208 for connecting to a broadband network, such as the Internet. The access point 200a may provide various computing devices with access to the broadband network. The network interface 208 may include one or more input/output (I/O) ports 210 through which a connection to a network, such as the Internet, may be provided. For example, the I/O ports 210 may include an Ethernet connection, a fiber optic connection, a broadband cable connection, a telephone line connection, or other types of wired communication connections. Alternatively or in addition to the I/O ports 210, the network interface 208 may include a cellular radio unit 212 that provides a connection to a mobile telephony system or cellular data network through which access to the Internet may be acquired.

The processor 202 may be coupled to the machine access control (MAC) layer 214. The MAC layer 214 may provide addressing and channel access control mechanisms between the network interface 208 and one or more devices associated with the access point 200a, such as wireless stations and/or range extenders. The MAC layer 214 may be connected to a physical layer 216, which may perform various encoding, signaling, and data transmission and reception functions. The physical layer 216 may include one or more transceivers 218 and a baseband processor 220 for carrying out the various functions of the physical layer 216. The physical layer 216 may be coupled to one or more wireless antennas (e.g., wireless antennas 222, 224, and 226) to support wireless communications with devices associated with the access point 200a, such as wireless stations and/or range extenders. Each of the transceivers 218 may be configured to provide communications using one or more frequency bands, for example 2.4 GHz, lower band 5 GHz, and higher band 5 GHz. The number of wireless antennas in the access point 200a is not limited to three as illustrated in FIG. 2A, but may include any number of antennas.

The processor 202 may also be coupled to a radio performance monitor unit 206 and a network performance monitor unit 207. The network performance monitor unit 207 may use information from the physical layer 216, the MAC layer 214, and/or the processor 202 to monitor and/or determine characteristics of a communication link between a wireless station and a radio of the access point 200a (e.g., the transceiver(s) 218 and/or the wireless antennas 222, 224, and 226). In some embodiments, the radio performance monitor unit 206 may receive information from the physical layer 216 and/or the MAC layer 214, and provide such information to the processor 202 for determination and/or monitoring of the performance of each radio of the access point 200a. The network performance monitor unit 207 may use information from the physical layer 216, the MAC layer 214, and/or the processor 202 to monitor and/or determine network performance characteristics of communications conducted by the access point 200a. The monitored communications may include the communications between a wireless station and the access point 200a and/or communications between a communication network and the access point 200a. In some embodiments, the network performance monitor unit 207 may receive information from the physical layer 216 and/or the MAC layer 214 and provide such information to the processor 202 for monitoring and/or determination of the network performance characteristics.

The access point 200a may also include a bus for connecting the various components of the access point 200a together, as well as hardware and/or software interfaces to enable communication among the various components. The access point 200a may also include various other components not illustrated in FIG. 2A. For example, the access point 200a may include a number of input, output, and processing components such as buttons, lights, switches, antennas, display screen or touchscreen, various connection ports, additional processors or integrated circuits, and many other components.

FIG. 2B is a component block diagram of another example of a wireless access point 200b suitable for implementing various embodiments. In various embodiments, the access point 200b may be similar to the access point 108 in FIG. 1. The wireless access point 200b illustrated in FIG. 2B is similar to and includes many of the same components as the wireless access point 200a described above with reference to FIG. 2A. The access point 200b may include a memory 230 in which may be stored processor-executable instructions for a radio performance monitor unit 232, and a network performance monitor unit 234. As illustrated in FIG. 2B, the radio performance monitor unit 232 may be implemented in software stored on a non-transitory medium (e.g., the memory 230) as processor-executable instructions configured to cause the processor 202 to perform functions similar to the radio performance monitor unit 206 described with reference to FIG. 2A. Similarly, the network performance monitor unit 234 may be implemented in software stored on a non-transitory medium (e.g., the memory 230) as processor-executable instructions configured to cause the processor 202 to perform functions similar to the network performance monitor unit 207 described with reference to FIG. 2A.

In some embodiments, the radio performance monitor unit 206, 232 and the network performance monitor unit 207, 234 may be implemented partially in hardware (as illustrated in FIG. 2A) and partially in software executing in a processor 202 (as illustrated in FIG. 2B).

A special type of access point is a “range extender” that is configured to relay network message traffic via wireless communication links between an access point (e.g., 200a, 200b) and wireless stations beyond the wireless communication range of the access point. FIG. 2C is a component block diagram of an example of a range extender 200c suitable for implementing various embodiments. The range extender 200c includes components that may be found in similar types of access points, including signal relays, wireless repeaters, signal boosters, FEMTO cells, and similar wireless devices. Typically, a range extender 200c communicates and operates in conjunction with an access point 200a, 200b and functions to relay communications between wireless stations and the access point 200a, 200b, thereby extending their communication range.

The range extender 200c may include at least one processor 240 that may be a general purpose processor configurable with processor-executable instructions to execute operations of the various embodiments, a specialized processor, such as a modem processor, configurable with processor-executable instructions to execute operations of the various embodiments in addition to a primary function, a dedicate hardware (e.g., “firmware”) circuit configured to perform operations of the various embodiments, or a combination of dedicated hardware/firmware and a programmable processor.

The processor 240 may be coupled to a memory 242. The memory 242 may be a non-transitory computer-readable storage medium that stores processor-executable instructions. The memory 242 may store an operating system, as well as user application software and executable instructions. The memory 242 may also store application data, such as an array data structure. The memory 242 may include one or more caches, ROM, RAM, EEPROM, SRAM, DRAM, and/or other types of memory. The processor 240 may read and write information to and from the memory 242. The memory 242 may also store instructions associated with one or more protocol stacks. A protocol stack generally includes computer executable instructions to enable communication using a radio access protocol or communication protocol.

In some embodiments, a radio performance monitor unit 250, and a network performance monitor unit 252 may be implemented in hardware as dedicated circuitry coupled to the processor 240. In some embodiments, the memory 242 may store processor-executable instructions for a radio performance monitor unit 244 and a network performance monitor unit 248 that may be executed in the processor 240. Thus, in various embodiments, the radio performance monitor unit 244, 250 and the network performance monitor unit 248, 252 may be implemented completely in software, completely in hardware, or partially in hardware and partially in software.

The processor 240 may be coupled to a MAC layer 254. The MAC layer 254 may provide addressing and channel access control mechanisms for coordinating communication links between wireless stations connected to the range extender 200c and an access point (e.g., 108, 200a, 200b) with which the range extender 200c is associated.

The MAC layer 254 may be connected to a physical layer 256, which may perform various encoding, signaling, and data transmission and reception functions on the range extender 200c. The physical layer 256 may include one or more baseband processors 258 for controlling the operation of one or more receivers 260-264 and one or more retransmitters 272-276. The receivers 260-264 may each receive a broadband network connection signal transmitted from an access point. The receivers 260-264 may receive signals through one or more wireless antennas 266-270. Each receiver 260-264 may include one or more amplifiers, filters, radios, and other components for performing reception operations. Each receiver 260-264 may operate on a different base or center frequency. For example, the receivers 260-264 may receive signals on different frequencies utilized by the transceiver(s) 218 of the access point 200a, 200b.

In some embodiments, the baseband processor(s) 258 may control the operation of one or more retransmitters 272-276. Each retransmitter 272-276 may retransmit a broadband network connection signal from a receiver 260-264. Each retransmitter 272-276 may transmit the signal to one or more wireless stations through one or more wireless antennas 278-282. The frequencies utilized by each retransmitter 72-276 may be the same frequencies or different frequencies utilized by the receivers 260-264.

In some embodiments, the radio performance monitor unit 244, 250 may use information from receivers 260-264, and/or retransmitters 272-276, the baseband processor(s) 258, and/or the processor 240 to monitor and/or determine characteristics of a communication link between a radio of the range extender 200c and a wireless station (e.g., the wireless stations 102, 104, 106). In some embodiments, the radio performance monitor unit 244, 250 may receive information from the receivers 260-264, and/or retransmitters 272-276, and may provide such information to the processor 240 for determination and/or monitoring of the performance of each radio of the range extender 200c.

In some embodiments, the network performance monitor unit 248, 252 may use information from the receivers 260-264, and/or retransmitters 272-276, the baseband processor(s) 258, and/or the processor 240 to monitor and/or determine network performance characteristics of communications conducted by the range extender 200c. Such communications may include communications between a wireless station and the range extender 200c, and/or communications between a communication network and the range extender 200c. In some embodiments, the network performance monitor unit 248, 252 may receive information from the receivers 260-264, and/or retransmitters 272-276 and provide such information to the processor 240 for monitoring and/or determination of the network performance characteristics.

Each receiver 260-264 and each retransmitter 272-276 may include various circuitry and components to enable the sending, receiving, and processing of radio signals, such as a modulator/demodulator component, a power amplifier, a gain stage, a digital signal processor (DSP), a signal amplifier, a filter, and other such components. Each of the receivers 260-264 and the retransmitters 272-276 may be configured to provide communications using one or more frequency bands, for example 2.4 GHz, lower band 5 GHz, higher band 5 GHz, or another frequency band. The number of receivers 260-264 and retransmitters 272-276 in the range extender 200c is not limited to three as illustrated in FIG. 2C, but may include any number of receivers and/or retransmitters. In some embodiments, there may be a one-to-one correspondence between receivers and retransmitters. In some embodiments, multiple receivers may share one retransmitter, and/or multiple retransmitters may share one receiver.

In some embodiments, the receivers 260-264 may also be configured to receive communications from various wireless stations associated with the range extender 200c, and the retransmitters 272-276 may be configured to transmit the communications from the wireless stations to another access point (e.g., the access point 200a, 200b), which may be in communication with a communication network (e.g., the communication network 110). In some embodiments, the retransmitters 272-276 may be configured to receive communications from various wireless stations associated with the range extender 200c, and the receivers 260, 262, and 264 may be configured to transmit the communications from the wireless stations to another access point (e.g., the access point 200a, 200b).

The range extender 200c may also include a bus for connecting the various components of the range extender 200c together, as well as hardware and/or software interfaces to enable communication among the various components. The range extender 200c may also include various other components not illustrated in FIG. 2C. For example, the range extender 200c may include a number of input, output, and processing components such as buttons, lights, switches, antennas, display screen or touchscreen, various connection ports, additional processors or integrated circuits, and many other components.

In some embodiments, the functions of the one or more receivers 260-264 may be combined with the functions of the one or more retransmitters 272-276 in transceivers 284-288 with both reception and transmission capabilities, as illustrated in FIG. 2D. For example, the transceivers 284-288 may be configured to receive communications from various wireless stations connected to the range extender 200d, as well as receive communications from an access point associated with the range extender 200d. The transceivers 284-288 may also be configured to transmit communications received from the access point to the wireless stations connected to the range extender 200d, and vice versa.

Since range extenders 200c, 200d and the like function as an access point to wireless stations and communicate via wireless links to an access point 200a, 200b, the various embodiments may be implemented in range extenders and access points in a similar manner. Therefore, various embodiments will be described below using the term “access point” as a general term and an example of wireless communication devices suitable for implementing various embodiments. However, the following example embodiments and references to an “access point” are not intended to limit the scope of the claims to exclude range extenders (e.g., 200c, 200d) and similar devices that function as an access point for wireless stations and relay network communications to an access point (including in some cases another range extender).

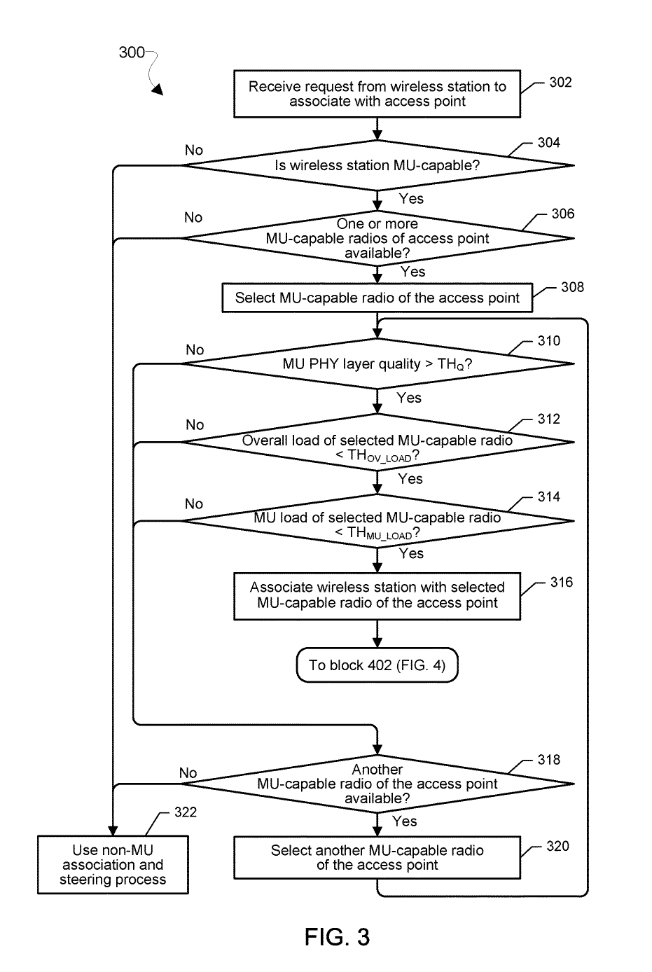

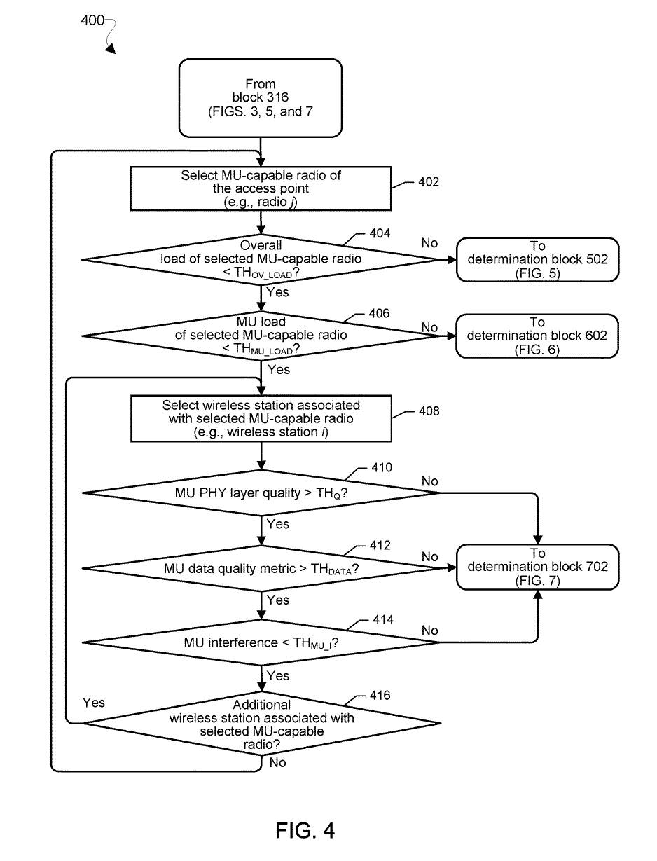

FIG. 3 is a process flow diagram illustrating a method 300 for managing radio utilization of a multi-radio access point to some embodiments. With reference to FIGS. 1-3, in various embodiments, the method 300 may be implemented by a processor (e.g., 202, 240) of an access point (e.g., 108, 200a, 200b, 200c, 200d).

In block 302, the processor of the access point may receive a request from a wireless station to associate with the access point. In some implementations, the request from the wireless station may include a generic request to associate with any radio of the access point. In some implementations, the request may include a request to associate with a specific radio of the access point.

In block 304, the processor of the access point may determine whether the wireless station is MU-capable. For example, the processor of the access point may receive information in the request indicating whether the wireless station is capable of conducting communications in an MU mode, for example, using MU-MIMO communications. As another example the processor of the access point may send a query message to the wireless station, and the wireless station may respond with an indication of whether the wireless station is MU-capable.

In response to determining that the wireless station is not MU-capable (i.e., determination block 304=“No”), the processor of the access point may use a non-MU association and steering process to determine whether to associate the wireless station with a radio of the access point that does not support (or is not currently supporting) MU communication in block 322. In some implementations, the non-MU association and steering process may include steering the wireless station to a radio of the access point that supports or is being used for MU communication, or to a radio of the access point that does not support or is not being used for MU communication.

In response to determining that the wireless station is MU-capable (i.e., determination block 304=“Yes”), the processor of the access point may determine whether an MU-capable radio of the access point is available in determination block 306. For example, the processor may determine a level of utilization of one or more MU-capable radios of the access point. The level of utilization of each MU-capable radio may be based on one or more criteria, such as overall load, MU load, and one or more of the most recently used modulation and coding scheme(s) (MCS). In some embodiments, the processor may determine whether an MU-capable radio is available based on the one or more criteria, such as whether any of the criteria meets a threshold. In some embodiments, the processor may rank or order two or more MU-capable radios using one or more criteria, and the processor may determine whether an MU-capable radio is available based on the ranking or ordering.

In response to determining that no MU-capable radio of the access point is available (i.e., determination block 306=“No”), the processor of the access point may use a non-MU association and steering process to determine whether to associate the wireless station with a radio of the access point that does not support MU communication in block 322.

In response to determining that one or more MU-capable radios of the access point is available (i.e., determination block 306=“Yes”), the processor of the access point may select an MU-capable radio of the access point in block 308. For example, the processor may select one MU-capable radio from among a plurality of MU-capable radios of the access point. In some implementations, the processor may select from among the plurality of MU-capable radios in a sequence. In some implementations, the processor may select from among the plurality of MU-capable radios according to one or more criteria, such as utilization of each radio, overall load of each radio, MU load of each radio, or other criteria. For example, the processor may select the MU-capable radio with the lowest utilization, overall load, and/or MU load.

In some implementations, the processor may select from among the plurality of MU-capable radios based on a capability of the radio. The capability of the radio may include one or more of a number of antennas associated with the radio, a number of simultaneous spatial streams that the radio is capable of transmitting and/or receiving, a maximum transmit power capability, and a maximum number of MU groups that the radio can support. In various implementations, the processor may select from among the plurality of MU-capable radios in a predetermined order, using a round-robin selection, or randomly from among the plurality of MU-capable radios.

In determination block 310, the processor of the access point may determine whether an MU physical layer quality (“MU PHY layer quality”) of a communication link between the selected radio of the access point and the wireless station exceeds a quality threshold (“TH_{Q}”). In some implementations, the quality threshold may indicate whether the MU physical layer quality can support MU communications (e.g., MU-MIMO communications) between the wireless station and the selected radio of the access point. In some implementations, the processor may use the selected MU-capable radio of the access point to send and/or receive one or more messages to the wireless station to determine the physical layer quality of the communication link. The physical layer quality may include, for example, a signal-to-noise ratio (SNR), a modulation and coding scheme (MCS), or another indication of the physical layer quality. The processor of the access point may then compare the determined MU physical layer quality to the quality threshold.

In response to determining that the MU physical layer quality of the communication link exceeds the quality threshold (i.e., determination block 310=“Yes”), the processor of the access point may determine whether an overall load of the selected MU-capable radio of the access point is below an overall load threshold (“TH_{OV}_{_}_{LOAD}”) in determination block 312. For example, the processor may determine an overall level of utilization of the selected MU-capable radio. In some implementations, the overall load of the selected radio may be based on an amount and/or type of traffic carried by the selected radio to and/or from one or more other wireless stations. In some embodiments, the overall load of the selected radio may be independent of a number of wireless stations associated with the selected radio. In some implementations, the overall load of the selected radio may be based on a number of wireless stations associated with the selected radio. In some implementations, the processor may assign a higher priority to traffic generated by a wireless station performing MU communications or operating in an MU mode when determining the overall load of the selected radio. For example, a radio operating in MU mode may provide a greater data rate to a wireless station and/or or may provide communications to a greater number of wireless stations than a radio operating in a non-MU mode (such as a single-user (SU) mode). In some embodiments, the processor may evaluate a capability of a radio operating in MU mode using a “MU gain” value, which may be an overall data throughput when operating in MU mode divided by an overall data throughput when the radio operates in non-MU mode (e.g., SU mode) for the same wireless station(s).

In response to determining that the overall load of the selected radio is below the overall load threshold (i.e., determination block 312=“Yes”), the processor of the access point may determine whether an MU load of the radio of the access point is below an MU load threshold (“TH_{MU}_{_}_{LOAD}”) in determination block 314. For example, the processor may determine an MU-specific level of utilization of the selected MU-capable radio. In some implementations, the MU load of the radio may be based on an amount and/or type of traffic carried by the selected radio to and/or from one or more wireless stations performing MU communications or operating in an MU mode. In some embodiments, the MU load of the selected radio may be independent of a number of wireless stations associated with the selected radio. In some embodiments, the MU load of the selected radio may be based on a number of wireless stations associated with the selected radio.

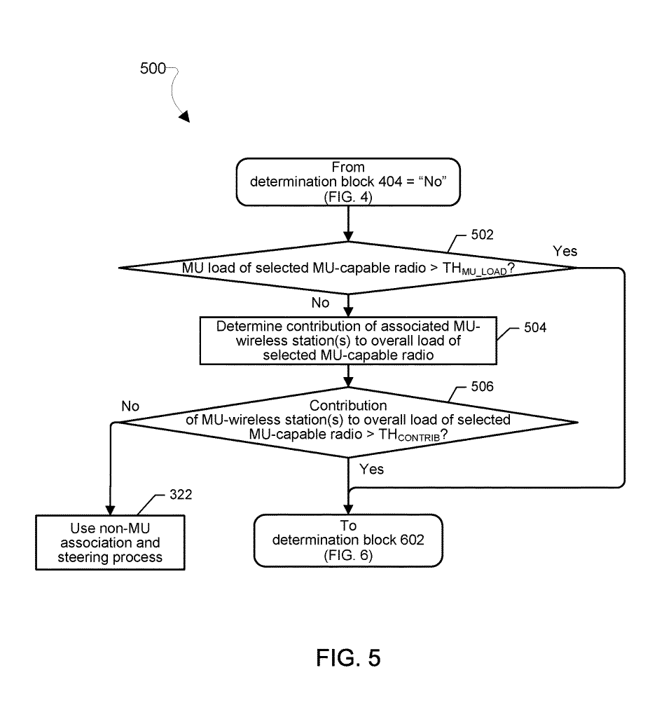

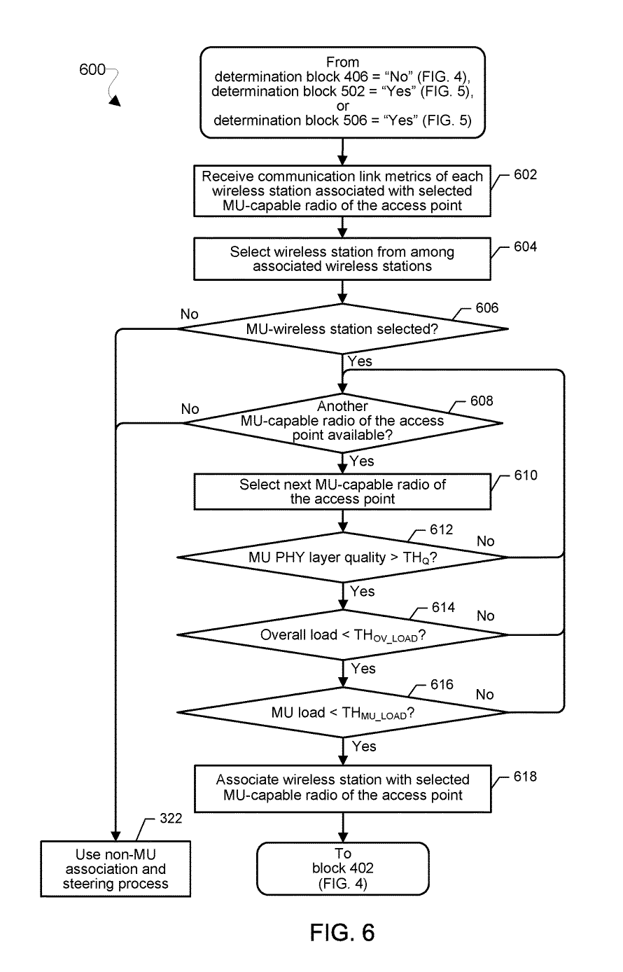

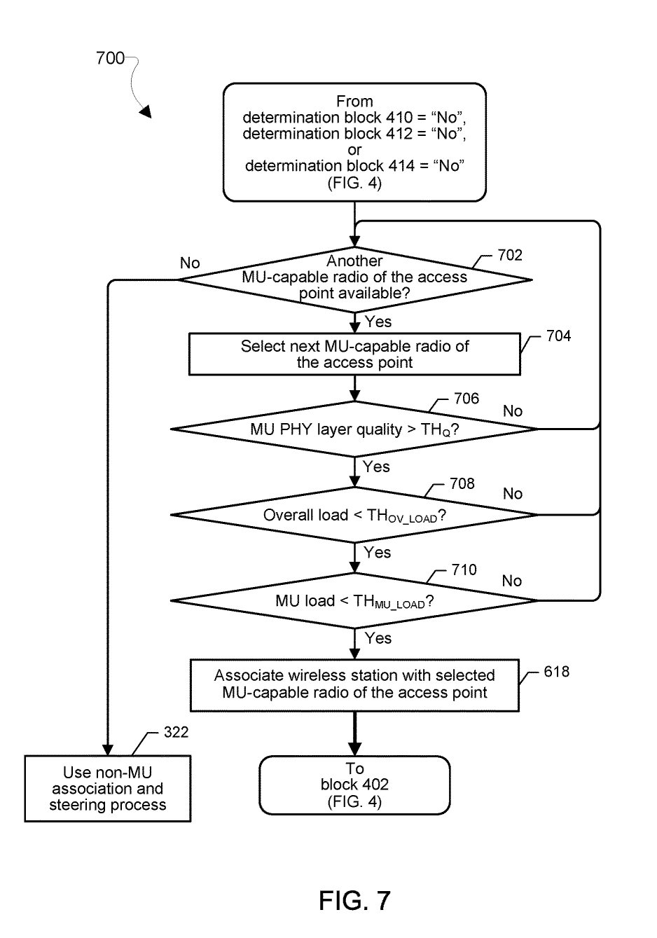

In response to determining that the multi-user load of the radio of the access point is below the MU load threshold (i.e., determination block 314=“Yes”), the processor of the access point may associate the wireless station with the selected MU-capable radio of the access point in block 316. The processor of the access point may then perform operations for monitoring communications of the wireless station with the selected MU-capable radio of the access point in method 400 as described with reference to FIG. 4.

In response to determining that the MU physical layer quality of the communication link does not exceed the quality threshold (i.e., determination block 310=“No”), in response to determining that the overall load of the selected radio is not below the overall load threshold (i.e., determination block 312=“No”), or in response to determining that the MU load of the radio of the access point is not below the MU load threshold (i.e., determination block 314=“No”), the processor of the access point may determine whether another MU-capable radio of the access point is available in determination block 318.

In response to determining that another MU-capable radio of the access point is not available (i.e., determination block 318=“No”), the processor of the access point may use a non-MU association and steering process to determine whether to associate the wireless station with a radio of the access point that is not operating in, or does not support, MU communication in block 322. In some embodiments, the radio may be an MU-capable radio that is not currently operating in MU mode.

In response to determining that another MU-capable radio of the access point is available (i.e., determination block 318=“Yes”), the processor of the access point may select another MU-capable radio of the access point in block 320. The processor of the access point may then determine for the newly selected MU-capable radio whether a physical layer quality of a communication link between the newly selected radio of the access point and the wireless station exceeds the quality threshold in determination block 310 as described above.

FIG. 4 is a process flow diagram illustrating a method 400 for monitoring communications of the wireless station with the selected MU-capable radio of the access point according to some embodiments. With reference to FIGS. 1-4, in various embodiments, the method 400 may be implemented by a processor (e.g., 202, 240) of an access point (e.g., 108, 200a, 200b, 200c, 200d).

In various implementations, the processor of an access point may use the method 400 to monitor and evaluate various aspects of the established communication link and/or communications between an MU-capable radio of the access point and one or more wireless stations associated with the MU-capable radio. The order of certain operations of the method 400 illustrated in FIG. 4 represents merely one implementation, and operations of the method 400 (for example, operations 404 and 406, and operations 410-416) may be performed in any sequence.

In block 402, the processor of the access point may select an MU-capable radio of the access point. For ease of reference, the selected MU-capable radio of the access point may be referred to as radio j.

In determination block 404, the processor of the access point may determine whether an overall load of the selected MU-capable radio of the access point is below an overall load threshold (“TH_{OV}_{_}_{LOAD”}). In some implementations, the overall load and the overall load threshold may be similar to the overall load and the overall load threshold described with reference to determination block 312 of the method 300 (FIG. 3).

In response to determining that the overall load of the selected radio is not below (i.e., equals or exceeds) the overall load threshold (i.e., determination block 404=“No”), the processor of the access point may perform operations of the method 500 described with reference to FIG. 5.

In response to determining that the overall load of the selected radio is below the overall load threshold (i.e., determination block 404=“Yes”), the processor of the access point may determine whether an MU load of the radio of the access point is below an MU load threshold (“TH_{MU}_{_}_{LOAD}”) in determination block 406. In some implementations, the MU load and the MU load threshold may be similar to the MU load and the MU load threshold described with reference to determination block 314 of the method 300 (FIG. 3).

In response to determining that the multi-user load of the radio of the access point is not below (i.e., equals or exceeds) the MU load threshold (i.e., determination block 406=“No”), the processor of the access point may perform operations of the method 600 described with reference to FIG. 6.

In response to determining that the MU load of the radio of the access point is below the MU load threshold (i.e., determination block 406=“Yes”), the processor of the access point may select a wireless station associated with the selected MU-capable radio in block 408. For ease of reference, the selected wireless station may be referred to as wireless station i.

In determination block 410, the processor of the access point may determine whether an MU physical layer quality (“MU PHY layer quality”) of a communication link between the selected radio (e.g., radio j) of the access point and the selected wireless station (e.g., wireless station i) no longer exceeds (e.g., drops below) the quality threshold (“TH_{Q}”). In some implementations, the quality threshold may be set as an MU physical layer quality at which MU communications (e.g., MU-MIMO communications) between the wireless station and the selected radio of the access point can be reliably maintained. The MU physical layer quality may include for example, a signal-to-noise ratio (SNR), a modulation and coding scheme (MCS), or another indication of the physical layer quality. In determination block 410, the processor of the access point may compare the determined physical layer quality to the quality threshold.

In response to determining that the MU physical layer quality of the communication link does not exceed the quality threshold (i.e., determination block 410=“No”), the processor of the access point may perform operations of the method 700 described with reference to FIG. 7.

In response to determining that the physical layer quality of the communication link exceeds the quality threshold (i.e., determination block 410=“Yes”), the processor of the access point may determine whether an MU data quality metric of the communication link exceeds a data quality threshold (“TH_{DATA”}) in determination block 412. In some implementations, the data quality threshold may indicate whether the MU data quality metric can support MU communications between the wireless station and the selected radio of the access point.

In some implementations, the evaluation of the MU data quality metric in determination block 412 may include a determination of a delay sensitivity of one or more data packets sent between (i.e., to and/or from) the wireless station i and the selected MU-capable radio of the access point j. In some implementations, the evaluation of the MU data quality metric in determination block 412 may include a determination of a priority of the one or more data packets. In some implementations, the evaluation of the MU data quality metric in determination block 412 may include a determination of a delay sensitivity and/or a priority of an application running on the selected wireless station that is sending and/or receiving the data packets. The determination of delay sensitivity may be based on, for example, an access class of the one or more data packets. The determination of delay sensitivity may also be based on an indication in a packet header of a priority and/or quality of service (QoS) requirement of the one or more data packets. The determination of delay sensitivity may also be based on a deep packet inspection (DPI) of a content portion of one or more of the data packets.

In some implementations, the evaluation of the MU data quality metric in determination block 412 may include a determination of a queue depth associated with the selected wireless station. For example, access class may include one or more data queues. The queue depth may provide an indication of data traffic frequency and/or volume associated with the selected wireless station.

In response to determining that the MU data quality metric of the communication link does not exceed the data quality threshold (i.e., determination block 412=“No”), the processor of the access point may perform operations of the method 700 described with reference to FIG. 7.

In response to determining that the MU data quality metric of the communication link exceeds the data quality threshold (i.e., determination block 412=“Yes”), the processor of the access point may determine whether an MU interference of the communication link is below an MU interference threshold (TH_{MU}_{_}_{I}) in determination block 414.

The MU interference may be based on a measurement of actual and/or potential MU signal interference between an MU signal sent over the communication link between the selected MU-capable radio and the selected wireless station, and another MU signal sent between the selected MU-capable radio and another wireless station. The MU interference may be represented in a metric, such as, signal to interference-plus-noise ratio (SINR) or another suitable metric.

In some implementations, the selected wireless station and one or more other wireless stations may be part of an MU group designated by the access point. For example, as part of MU operations, the access point may perform MU precoding (which may be an extension of transmit beamforming) to separate out available spatial transmission modes and to allocate one or more transmissions from the access point to each wireless station in an MU group. However, two or more beamformed signals to wireless stations in the MU group may nonetheless cross-interfere. Thus, the MU interference may include a measurement of actual signal interference between beamformed signals to two or more wireless stations in the MU group. Additionally or alternatively, the MU interference may include potential or anticipated MU interference, which the access point may determine based on signal characteristics of the beamformed signals to the two or more wireless stations in the MU group. In some implementations, the access point may use the measured and/or anticipated MU interference to determine whether to exclude a wireless station from an MU group, or to associate the wireless station with a different radio of the access point.

In response to determining that the MU interference of the communication link is not below (i.e., equals or exceeds) the MU interference threshold (i.e., determination block 414=“No”), the processor of the access point may perform operations of the method 700 described with reference to FIG. 7.

In response to determining that the MU interference of the communication link is below the MU interference threshold (i.e., determination block 414=“Yes”), the processor of the access point may determine whether an additional wireless station is associated with the selected MU-capable radio in determination block 416.

In response to determining that an additional wireless station is associated with the selected MU-capable radio (i.e., determination block 416=“Yes”), the processor of the access point may select another wireless station in block 408 and may perform operations 410-416 for the selected MU-capable radio and the newly selected wireless station.

In response to determining that an additional wireless station is not associated with the selected MU-capable radio (i.e., determination block 416=“No”), the processor of the access point may select another MU-capable radio of the access point in block 402.

FIG. 5 is a process flow diagram illustrating a method 500 for managing radio utilization of a multi-radio access point according to some embodiments. With reference to FIGS. 1-5, in various embodiments, the method 500 may be implemented by a processor (e.g., 202, 240) of an access point (e.g., 108, 200a, 200b, 200c, 200d).

In determination block 502, the processor of the access point may determine whether an MU load of the selected MU-capable radio of the access point exceeds MU load threshold (“TH_{MU}_{_}_{LOAD”}). In some implementations, the MU load and the MU load threshold may be similar to the MU load and the MU load threshold described with reference to determination block 314 of the method 300 (FIG. 3).

In response to determining that the MU load of the radio of the access point does not exceed the MU load threshold (i.e., determination block 502=“No”), the processor of the access point may determine a contribution of wireless stations associated with the selected MU-capable radio and operating in an MU mode (“MU-wireless stations”) to the overall load of the selected MU-capable radio in block 504. For example, the processor of the access point may determine a level or an amount of load contributed by the one or more MU-wireless stations associated with the selected MU-capable radio. In some implementations, the overall load may include load contributed by wireless stations operating in a non-MU mode as well as in an MU mode. In some embodiments, the access point processor may determine a proportion of the overall load that is attributable to wireless stations operating in MU mode. In some embodiments, the access point processor may determine a percentage of the overall load that is attributable to wireless stations operating in MU mode.

In determination block 506, the processor of the access point may determine whether the contribution of the one or more wireless stations operating in an MU mode (MU-wireless stations) to the overall load of the selected MU-capable radio of the access point exceeds a threshold contribution (“TH_{CONTRIB}”). For example, the combined contribution of all associated MU-wireless stations to the overall load of the selected MU-capable radio may be compared to the threshold contribution.

In response to determining that the contribution of the MU-wireless station(s) to the overall load of the selected MU-capable radio of the access point does not exceed the threshold contribution (i.e., determination block 506=“No”), the processor of the access point may use a non-MU association and steering process to determine whether to associate the wireless station with a radio of the access point that does not support MU communication in block 322.

In response to determining that the MU load of the radio of the access point exceeds the MU load threshold (i.e., determination block 502=“Yes”), or in response to determining that the contribution of the MU-wireless station(s) to the overall load of the selected MU-capable radio of the access point exceeds the threshold contribution (i.e., determination block 506=“Yes”), the processor of the access point may perform operations the method 600 as described with reference to FIG. 6.

FIG. 6 is a process flow diagram illustrating a method 600 for managing radio utilization of a multi-radio access point according to some embodiments. With reference to FIGS. 1-6, in various embodiments, the method 600 may be implemented by a processor (e.g., 202, 240) of an access point (e.g., 108, 200a, 200b, 200c, 200d).

In block 602, the processor of the access point may receive communication link metrics of each wireless station associated with the selected MU-capable radio of the access point. The communication link metrics may include, for example, a signal-to-noise ratio (SNR), or a modulation and coding scheme (MCS). The communication link metrics may also include, for example, a data rate (e.g., an average data rate, a highest data rate), a data throughput, an error rate (e.g., a packet error rate), or another indication of the MU physical layer quality of the communication link between each wireless station and the MU-capable radio of the access point.

Based on the communication link metrics, the processor of the access point may select a wireless station from among the wireless stations associated with the MU-capable radio of the access point in block 604. In some implementations, the processor of the access point may select a wireless station having a lowest communication link metric, such as a lowest signal-to-noise ratio, or a lowest modulation and coding scheme.

In determination block 606, the processor of the access point may determine whether an MU-wireless station (i.e., a wireless station operating in an MU mode) is selected. In some implementations, based on the received communication link metrics the processor of the access point may select a wireless station operating in MU mode, or a wireless station operating in a non-MU mode.

In response to determining that an MU-wireless station is not selected (i.e., determination block 606=“No”), the processor of the access point may use a non-MU association and steering process to determine whether to associate the selected non-MU wireless station with a radio of the access point that does not support MU communication in block 322.

In response to determining that an MU-wireless station is selected (i.e., determination block 606=“Yes”), the processor of the access point may determine whether another MU-capable radio of the access point is available in determination block 608.

In response to determining that another MU-capable radio of the access point is not available (i.e., determination block 608=“No”), the processor of the access point may use a non-MU association and steering process to determine whether to associate the wireless station with a radio of the access point that does not support MU communication in block 322.

In response to determining that another MU-capable radio of the access point is available (i.e., determination block 608=“Yes”), the processor of the access point may select a next MU-capable radio of the access point in block 610.

In determination block 612, the processor of the access point may determine whether an MU physical layer quality (“MU PHY layer quality”) of a communication link between the selected MU-capable radio of the access point and the wireless station exceeds a quality threshold (“TH_{Q}”). In some implementations, the MU physical layer quality and the quality threshold may be similar to the MU physical layer quality and the quality threshold described with reference to determination block 310 of the method 300 (FIG. 3).

In response to determining that the MU physical layer quality of the communication link does not exceed the quality threshold (i.e., determination block 612=“No”), the processor of the access point may determine whether another MU-capable radio of the access point is available in determination block 608.

In response to determining that the MU physical layer quality of the communication link exceeds the quality threshold (i.e., determination block 612=“Yes”), the processor of the access point may determine whether an overall load of the selected radio of the access point is below an overall load threshold (“TH_{OV}_{_}_{LOAD}”) in determination block 614. In some implementations, the overall load threshold may be similar to the overall load threshold described with reference to determination block 312 of the method 300 (FIG. 3).

In response to determining that the overall load of the selected radio is not below the overall load threshold (i.e., determination block 614=“No”), the processor of the access point may determine whether another MU-capable radio of the access point is available in determination block 608.

In response to determining that the overall load of the selected radio is below the overall load threshold (i.e., determination block 614=“Yes”), the processor of the access point may determine whether an MU load of the radio of the access point is below an MU load threshold (“TH_{MU}_{_}_{LOAD}”) in determination block 616. In some implementations, the MU load and the MU load threshold may be similar to the MU load and the MU load threshold described with reference to determination block 314 of the method 300 (FIG. 3).

In response to determining that the MU load of the radio of the access point is not below the MU load threshold (i.e., determination block 616=“No”), the processor of the access point may determine whether another MU-capable radio of the access point is available in determination block 608.

In response to determining that the MU load of the radio of the access point is below the MU load threshold (i.e., determination block 616=“Yes”), the processor of the access point may associate the wireless station with the selected next MU-capable radio of the access point in block 618. In some embodiments, the processor may send to the wireless station a message instructing the wireless station to associate with the selected MU-capable radio of the access point.

The processor of the access point may then perform operations for monitoring communications of the wireless station with the selected MU-capable radio of the access point in method 400 as described with reference to FIG. 4.

FIG. 7 is a process flow diagram illustrating a method 700 for managing radio utilization of a multi-radio access point according to some embodiments. With reference to FIGS. 1-7, in various embodiments, the method 700 may be implemented by a processor (e.g., 202, 240) of an access point (e.g., 108, 200a, 200b, 200c, 200d).

In block 702, the processor of the access point may determine whether another MU-capable radio of the access point is available.

In response to determining that another MU-capable radio of the access point is not available (i.e., determination block 702=“No”), the processor of the access point may use a non-MU association and steering process to determine whether to associate the wireless station with a radio of the access point that does not support MU communication in block 322.

In response to determining that another MU-capable radio of the access point is available (i.e., determination block 702=“Yes”), the processor of the access point may select a next MU-capable radio of the access point in block 704.

In determination block 706, the processor of the access point may determine whether an MU physical layer quality (“MU PHY layer quality”) of a communication link between the selected MU-capable radio of the access point and the wireless station exceeds a quality threshold (“TH_{Q}”). In some implementations, the MU physical layer quality and the quality threshold may be similar to the MU physical layer quality and the quality threshold described with reference to determination block 310 of the method 300 (FIG. 3.)

In response to determining that the MU physical layer quality of the communication link does not exceed the quality threshold (i.e., determination block 706=“No”), the processor of the access point may determine whether another MU-capable radio of the access point is available in determination block 702.

In response to determining that the MU physical layer quality of the communication link exceeds the quality threshold (i.e., determination block 706=“Yes”), the processor of the access point may determine may determine whether an overall load of the selected radio of the access point is below an overall load threshold (“TH_{OV}_{_}_{LOAD”}) in determination block 708. In some implementations, the overall load threshold may be similar to the overall load threshold described with reference to determination block 312 of the method 300 (FIG. 3).

In response to determining that the overall load of the selected radio is not below the overall load threshold (i.e., determination block 708=“No”), the processor of the access point may determine whether another MU-capable radio of the access point is available in determination block 702.

In response to determining that the overall load of the selected radio is below the overall load threshold (i.e., determination block 708=“Yes”), the processor of the access point may determine whether an MU load of the radio of the access point is below an MU load threshold (“TH_{MU}_{_}_{LOAD”}) in determination block 710. In some implementations, the MU load and the MU load threshold may be similar to the MU load and the MU load threshold described with reference to determination block 314 of the method 300 (FIG. 3).

In response to determining that the MU load of the radio of the access point is not below the MU load threshold (i.e., determination block 710=“No”), the processor of the access point may determine whether another MU-capable radio of the access point is available in determination block 702.

In response to determining that the MU load of the radio of the access point is below the MU load threshold (i.e., determination block 710=“Yes”), the processor of the access point may associate the wireless station with the selected next MU-capable radio of the access point in block 618 of the method 600 as described with reference to FIG. 6. The processor of the access point may then perform operations for monitoring communications of the wireless station with the selected MU-capable radio of the access point in method 400 as described with reference to FIG. 4.

The various embodiments may improve the function of a multi-radio wireless access point by improving the utilization of radios of the wireless access point. In particular, the various embodiments may improve the functioning of an access point by performing proactive and responsive steering of wireless stations to radios of access point. The various embodiments thereby improve communication resource utilization and wireless communication quality and capacity provided by the access point.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 300, 400, 500, 600, and 700 may be substituted for or combined with one or more operations of the methods 300, 400, 500, 600, and 700, and vice versa.

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present embodiments. Various modifications to these embodiments will be readily apparent to those skilled in the art, and the generic principles defined herein may be applied to other embodiments without departing from the spirit or scope of the embodiments. Thus, various embodiments are not intended to be limited to the embodiments shown herein but are to be accorded the widest scope consistent with the following claims and the principles and novel features disclosed herein.

What is claimed is:

1. A method of managing radio utilization of an access point, comprising:
determining whether a multi-user (MU) physical layer quality of a communication link between a radio of the access point and a wireless station exceeds a quality threshold in response to receiving at the access point an access request from the wireless station;
determining whether a load of the radio of the access point is below a load threshold in response to determining that the MU physical layer quality of the communication link exceeds the quality threshold; and
associating the wireless station with the radio of the access point in response to determining that the load of the radio of the access point is below the load threshold.

2. The method of claim 1,
wherein determining whether the load of the radio of the access point is below the load threshold comprises determining whether an overall load of the radio is below an overall load threshold, and
wherein associating the wireless station with the radio of the access point comprises associating the wireless station with the radio in response to determining that the overall load of the radio is below the overall load threshold.

3. The method of claim 1, further comprising:
wherein determining whether the load of the radio of the access point is below the load threshold comprises determining whether an MU load of the radio is below an MU load threshold, and
wherein associating the wireless station with the radio of the access point comprises associating the wireless station with the radio in response to determining that the MU load of the radio is below the MU load threshold.

4. A method of managing radio utilization of an access point, comprising:
determining whether a load of a first radio of the access point is below a load threshold, wherein one or more wireless stations are associated with the first radio;
selecting a wireless station associated with the first radio in response to determining that the load is below the load threshold;
determining whether a multi-user (MU) physical layer quality of a communication link between the first radio of the access point and the selected wireless station exceeds a quality threshold; and
associating the selected wireless station with a second radio of the access point in response to determining that the MU physical layer quality of the communication link between the first radio of the access point and the selected wireless station does not exceed the quality threshold.

5. The method of claim 4, wherein associating the selected wireless station with the second radio of the access point in response to determining that the MU physical layer quality of the communication link between the first radio of the access point and the wireless station does not exceed the quality threshold comprises:
determining whether an MU physical layer quality of a second communication link between the second radio and the wireless station exceeds the quality threshold; and
associating the selected wireless station with the second radio in response to determining that the MU physical layer quality exceeds the quality threshold.

6. The method of claim 5, further comprising:
determining whether an overall load of the second radio is below an overall load threshold in response to determining that the MU physical layer quality of the second communication link exceeds the quality threshold; and
associating the selected wireless station with the second radio in response to determining that the overall load of the second radio is below the overall load threshold.

7. The method of claim 6, further comprising:
determining whether an MU load of the second radio is below an MU load threshold in response to determining that the overall load of the second radio is below the overall load threshold; and
associating the selected wireless station with the second radio in response to determining that the MU load of the second radio is below the MU load threshold.

8. The method of claim 4, wherein determining whether the load of the first radio of the access point is below the load threshold comprises determining whether an overall load of the first radio is below an overall load threshold, and
wherein associating the selected wireless station with the second radio of the access point comprises:
determining whether an MU load of the first radio is greater than an MU load threshold in response to determining that the overall load of the first radio is not below the overall load threshold; and
associating the selected wireless station with the second radio of the access point in response to determining that the MU load of the first radio is greater than the MU load threshold.

9. The method of claim 8, further comprising:
determining a contribution of wireless stations associated with the first radio and operating in an MU mode to the overall load of the first radio in response to determining that the MU load of the first radio is not greater than an MU load threshold;
determining whether the contribution of the associated wireless stations operating in the MU mode to the overall load of the first radio exceeds a threshold contribution; and
associating one of the associated wireless stations with the second radio of the access point in response to determining that the contribution of the associated wireless stations operating in the MU mode to the overall load of the first radio exceeds the threshold contribution.

10. The method of claim 4, wherein determining whether the load of the first radio of the access point is below the load threshold comprises determining whether an MU load of the first radio is below an MU load threshold, and
wherein associating the selected wireless station with the second radio of the access point comprises:
determining whether an MU physical layer quality of a second communication link between the second radio and the selected wireless station exceeds a quality threshold;
determining whether a load of the second radio is below a load threshold in response to determining that the MU physical layer quality of the second communication link exceeds the quality threshold; and
associating the selected wireless station with the second radio in response to determining that the load of the second radio is below the load threshold.

11. The method of claim 10,
wherein determining whether the load of the second radio is below the load threshold comprises determining whether an overall load of the second radio is below an overall load threshold, and
wherein associating the selected wireless station with the second radio comprises associating the selected wireless station with the second radio in response to determining that the overall load of the second radio is below the overall load threshold.

12. The method of claim 10,
wherein determining whether the load of the second radio is below the load threshold comprises determining whether an MU load of the second radio is below an MU load threshold, and
wherein associating the selected wireless station with the second radio comprises associating the selected wireless station with the second radio in response to determining that the MU load of the second radio of the access point is below the MU load threshold.

13. The method of claim 4, further comprising:
determining whether an MU data quality metric of the communication link exceeds a data quality threshold in response to determining that the MU physical layer quality of the communication link exceeds the quality threshold; and
associating the selected wireless station with the second radio of the access point in response to determining that the MU data quality metric of the communication link does not exceed the data quality threshold.

14. The method of claim 13, wherein associating the selected wireless station with the second radio of the access point in response to determining that the MU data quality metric of the communication link does not exceed the data quality threshold comprises:
determining whether an MU physical layer quality of a second communication link between the second radio and the wireless station exceeds the quality threshold; and
associating the selected wireless station with the second radio in response to determining that the MU physical layer quality exceeds the quality threshold.

15. The method of claim 14, further comprising:
determining whether an overall load of the second radio is below an overall load threshold in response to determining that the MU physical layer quality of the second communication link between the second radio and the wireless station exceeds the quality threshold; and
associating the selected wireless station with the second radio in response to determining that the overall load of the second radio is below the overall load threshold.

16. The method of claim 15, further comprising:
determining whether an MU load of the second radio is below an MU load threshold in response to determining that the overall load of the second radio is below the overall load threshold; and
associating the selected wireless station with the second radio in response to determining that the MU load of the second radio is below the MU load threshold.

17. The method of claim 13, further comprising:
determining whether an MU interference of the communication link is below an MU interference threshold in response to determining that the MU data quality metric of the communication link exceeds the data quality threshold; and
associating the selected wireless station with the second radio of the access point in response to determining that the MU interference of the communication link is not below the MU interference threshold.

18. The method of claim 17, wherein associating the selected wireless station with the second radio of the access point in response to determining that the MU interference of the communication link is not below the MU interference threshold comprises:
determining whether an MU physical layer quality of a second communication link between the second radio and the selected wireless station exceeds the quality threshold; and
associating the selected wireless station with the second radio in response to determining that the MU physical layer quality exceeds the quality threshold.

19. The method of claim 18, further comprising:
determining whether an overall load of the second radio is below an overall load threshold in response to determining that the MU physical layer quality of the second communication link between the second radio and the selected wireless station exceeds the quality threshold; and
associating the selected wireless station with the second radio in response to determining that the overall load of the second radio is below the overall load threshold.

20. The method of claim 19, further comprising:
determining whether an MU load of the second radio is below an MU load threshold in response to determining that the overall load of the second radio is below the overall load threshold; and
associating the selected wireless station with the second radio in response to determining that the MU load of the second radio is below the MU load threshold.

21. An access point, comprising:
a radio;
a memory; and
a processor coupled to the memory and the radio and configured with processor-executable instructions to:
determine whether a multi-user (MU) physical layer quality of a communication link between the radio of the access point and a wireless station exceeds a quality threshold in response to receiving at the access point an access request from the wireless station;
determine whether a load of the radio of the access point is below a load threshold in response to determining that the MU physical layer quality of the communication link exceeds the quality threshold; and
associate the wireless station with the radio of the access point in response to determining that the load of the radio of the access point is below the load threshold.

22. The access point of claim 21, wherein the processor is further configured with processor-executable instructions to:
determine whether an overall load of the radio is below an overall load threshold, and
associate the wireless station with the radio in response to determining that the overall load of the radio is below the overall load threshold.

23. The access point of claim 21, wherein the processor is further configured with processor-executable instructions to:
determine whether an MU load of the radio is below an MU load threshold, and
associate the wireless station with the radio in response to determining that the MU load of the radio is below the MU load threshold.

24. An access point, comprising:
a first radio;
a second radio;
a memory; and
a processor coupled to the first radio, the second radio, and the memory and configured with processor-executable instructions to:
determine whether a load of the first radio of the access point is below a load threshold, wherein one or more wireless stations are associated with the first radio;
select a wireless station associated with the first radio in response to determining that the load is below the load threshold;
determine whether a multi-user (MU) physical layer quality of a communication link between the first radio of the access point and the selected wireless station exceeds a quality threshold; and
associate the selected wireless station with a second radio of the access point in response to determining that the MU physical layer quality of the communication link between the first radio of the access point and the selected wireless station does not exceed the quality threshold.

25. The access point of claim 24, wherein the processor is further configured with processor-executable instructions to:
determine whether an MU physical layer quality of a second communication link between the second radio and the wireless station exceeds the quality threshold; and
associate the selected wireless station with the second radio in response to determining that the MU physical layer quality exceeds the quality threshold.

26. The access point of claim 25, wherein the processor is further configured with processor-executable instructions to:
determine whether an overall load of the second radio is below an overall load threshold in response to determining that the MU physical layer quality of the second communication link exceeds the quality threshold; and
associate the selected wireless station with the second radio in response to determining that the overall load of the second radio is below the overall load threshold.

27. The access point of claim 26, wherein the processor is further configured with processor-executable instructions to:
determine whether an MU load of the second radio is below an MU load threshold in response to determining that the overall load of the second radio is below the overall load threshold; and
associate the selected wireless station with the second radio in response to determining that the MU load of the second radio is below the MU load threshold.

28. The access point of claim 24, wherein the processor is further configured with processor-executable instructions to:
determine whether an overall load of the first radio is below an overall load threshold;
determine whether an MU load of the first radio is greater than an MU load threshold in response to determining that the overall load of the first radio is not below the overall load threshold; and
associate the selected wireless station with the second radio of the access point in response to determining that the MU load of the first radio is greater than the MU load threshold.

29. The access point of claim 28, wherein the processor is further configured with processor-executable instructions to:
determine a contribution of wireless stations associated with the first radio and operating in an MU mode to the overall load of the first radio in response to determining that the MU load of the first radio is not greater than an MU load threshold;
determine whether the contribution of the associated wireless stations operating in the MU mode to the overall load of the first radio exceeds a threshold contribution; and
associate one of the associated wireless stations with the second radio of the access point in response to determining that the contribution of the associated wireless stations to the overall load of the second radio exceeds the threshold contribution.

30. The access point of claim 24, wherein the processor is further configured with processor-executable instructions to:
determine whether the load of the first radio of the access point is below the load threshold comprises determining whether an MU load of the first radio is below an MU load threshold;
determine whether an MU physical layer quality of a second communication link between the second radio and the selected wireless station exceeds a quality threshold;
determine whether a load of the second radio is below a load threshold in response to determining that the MU physical layer quality of the second communication link exceeds the quality threshold; and
associate the selected wireless station with the second radio in response to determining that the load of the second radio is below the load threshold.

31. The access point of claim 30, wherein the processor is further configured with processor-executable instructions to:
determine whether an overall load of the second radio is below an overall load threshold, and
associate the selected wireless station with the second radio in response to determining that the overall load of the second radio is below the overall load threshold.

32. The access point of claim 30, wherein the processor is further configured with processor-executable instructions to:
determine whether an MU load of the second radio is below an MU load threshold, and
associate the selected wireless station with the second radio in response to determining that the MU load of the second radio of the access point is below the MU load threshold.

33. The access point of claim 24, wherein the processor is further configured with processor-executable instructions to:
determine whether an MU data quality metric of the communication link exceeds a data quality threshold in response to determining that the MU physical layer quality of the communication link exceeds the quality threshold; and
associate the selected wireless station with the second radio of the access point in response to determining that the MU data quality metric of the communication link does not exceed the data quality threshold.

34. The access point of claim 33, wherein the processor is further configured with processor-executable instructions to:
determine whether an MU physical layer quality of a second communication link between the second radio and the wireless station exceeds the quality threshold; and
associate the selected wireless station with the second radio in response to determining that the MU physical layer quality exceeds the quality threshold.

35. The access point of claim 34, wherein the processor is further configured with processor-executable instructions to:
determine whether an overall load of the second radio is below an overall load threshold in response to determining that the MU physical layer quality of the second communication link between the second radio and the wireless station exceeds the quality threshold; and
associate the selected wireless station with the second radio in response to determining that the overall load of the second radio is below the overall load threshold.

36. The access point of claim 35, wherein the processor is further configured with processor-executable instructions to:
determine whether an MU load of the second radio is below an MU load threshold in response to determining that the overall load of the second radio is below the overall load threshold; and
associate the selected wireless station with the second radio in response to determining that the MU load of the second radio is below the MU load threshold.

37. The access point of claim 33, wherein the processor is further configured with processor-executable instructions to:
determine whether an MU interference of the communication link is below an MU interference threshold in response to determining that the MU data quality metric of the communication link exceeds the data quality threshold; and
associate the selected wireless station with the second radio of the access point in response to determining that the MU interference of the communication link is not below the MU interference threshold.

38. The access point of claim 37, wherein the processor is further configured with processor-executable instructions to:
determine whether an MU physical layer quality of a second communication link between the second radio and the selected wireless station exceeds the quality threshold; and
associate the selected wireless station with the second radio in response to determining that the MU physical layer quality exceeds the quality threshold.

39. The access point of claim 38, wherein the processor is further configured with processor-executable instructions to:
determine whether an overall load of the second radio is below an overall load threshold in response to determining that the MU physical layer quality of the second communication link between the second radio and the selected wireless station exceeds the quality threshold; and
associate the selected wireless station with the second radio in response to determining that the overall load of the second radio is below the overall load threshold.

40. The access point of claim 39, wherein the processor is further configured with processor-executable instructions to:
determine whether an MU load of the second radio is below an MU load threshold in response to determining that the overall load of the second radio is below the overall load threshold; and
associate the selected wireless station with the second radio in response to determining that the MU load of the second radio is below the MU load threshold.

41. A non-transitory processor-readable storage medium having stored thereon processor-executable instructions configured to cause a processor of an access point to perform operations comprising:
determining whether a multi-user (MU) physical layer quality of a communication link between a radio of the access point and a wireless station exceeds a quality threshold in response to receiving at the access point an access request from the wireless station;
determining whether a load of the radio of the access point is below a load threshold in response to determining that the MU physical layer quality of the communication link exceeds the quality threshold; and
associating the wireless station with the radio of the access point in response to determining that the load of the radio of the access point is below the load threshold.

42. The non-transitory processor-readable storage medium of claim 41, wherein the stored processor-executable instructions are configured to cause the processor of the access point to perform operations such that:
determining whether the load of the radio of the access point is below the load threshold comprises determining whether an overall load of the radio is below an overall load threshold, and
associating the wireless station with the radio of the access point comprises associating the wireless station with the radio in response to determining that the overall load of the radio is below the overall load threshold.

43. The non-transitory processor-readable storage medium of claim 41, wherein the stored processor-executable instructions are configured to cause the processor of the access point to perform operations such that:
determining whether the load of the radio of the access point is below the load threshold comprises determining whether an MU load of the radio is below an MU load threshold, and
associating the wireless station with the radio of the access point comprises associating the wireless station with the radio in response to determining that the MU load of the radio is below the MU load threshold.

44. A non-transitory processor-readable storage medium having stored thereon processor-executable instructions configured to cause a processor of an access point to perform operations comprising:
determining whether a load of a first radio of the access point is below a load threshold, wherein one or more wireless stations are associated with the first radio;
selecting a wireless station associated with the first radio in response to determining that the load is below the load threshold;
determining whether a multi-user (MU) physical layer quality of a communication link between the first radio of the access point and the selected wireless station exceeds a quality threshold; and
associating the selected wireless station with a second radio of the access point in response to determining that the MU physical layer quality of the communication link between the first radio of the access point and the selected wireless station does not exceed the quality threshold.

45. The non-transitory processor-readable storage medium of claim 44, wherein the stored processor-executable instructions are configured to cause the processor of the access point to perform operations such that associating the selected wireless station with the second radio of the access point in response to determining that the MU physical layer quality of the communication link between the first radio of the access point and the wireless station does not exceed the quality threshold comprises:
determining whether an MU physical layer quality of a second communication link between the second radio and the wireless station exceeds the quality threshold; and
associating the selected wireless station with the second radio in response to determining that the MU physical layer quality exceeds the quality threshold.

46. The non-transitory processor-readable storage medium of claim 45, wherein the stored processor-executable instructions are configured to cause the processor of the access point to perform operations such that:
determining whether an overall load of the second radio is below an overall load threshold in response to determining that the MU physical layer quality of the second communication link exceeds the quality threshold; and
associating the selected wireless station with the second radio in response to determining that the overall load of the second radio is below the overall load threshold.

47. The non-transitory processor-readable storage medium of claim 46, wherein the stored processor-executable instructions are configured to cause the processor of the access point to perform operations such that:
determining whether an MU load of the second radio is below an MU load threshold in response to determining that the overall load of the second radio is below the overall load threshold; and
associating the selected wireless station with the second radio in response to determining that the MU load of the second radio is below the MU load threshold.

48. The non-transitory processor-readable storage medium of claim 44, wherein the stored processor-executable instructions are configured to cause the processor of the access point to perform operations such that determining whether the load of the first radio of the access point is below the load threshold comprises determining whether an overall load of the first radio is below an overall load threshold, and
wherein the stored processor-executable instructions are configured to cause the processor of the access point to perform operations such that associating the selected wireless station with the second radio of the access point comprises:
determining whether an MU load of the first radio is greater than an MU load threshold in response to determining that the overall load of the first radio is not below the overall load threshold; and
associating the selected wireless station with the second radio of the access point in response to determining that the MU load of the first radio is greater than the MU load threshold.

49. The non-transitory processor-readable storage medium of claim 48, wherein the stored processor-executable instructions are configured to cause the processor of the access point to perform operations further comprising:
determining a contribution of wireless stations associated with the first radio and operating in an MU mode to the overall load of the first radio in response to determining that the MU load of the first radio is not greater than an MU load threshold;
determining whether the contribution of the associated wireless stations operating in the MU mode to the overall load of the first radio exceeds a threshold contribution; and
associating one of the associated wireless stations with the second radio of the access point in response to determining that the contribution of the associated wireless stations operating in the MU mode to the overall load of the first radio exceeds the threshold contribution.

50. The non-transitory processor-readable storage medium of claim 44, wherein the stored processor-executable instructions are configured to cause the processor of the access point to perform operations such that determining whether the load of the first radio of the access point is below the load threshold comprises determining whether an MU load of the first radio is below an MU load threshold, and
wherein the stored processor-executable instructions are configured to cause the processor of the access point to perform operations such that associating the selected wireless station with the second radio of the access point comprises:
determining whether an MU physical layer quality of a second communication link between the second radio and the selected wireless station exceeds a quality threshold;
determining whether a load of the second radio is below a load threshold in response to determining that the MU physical layer quality of the second communication link exceeds the quality threshold; and
associating the selected wireless station with the second radio in response to determining that the load of the second radio is below the load threshold.

51. The non-transitory processor-readable storage medium of claim 44, wherein the stored processor-executable instructions are configured to cause the processor of the access point to perform operations such that
determining whether the load of the second radio is below the load threshold comprises determining whether an overall load of the second radio is below an overall load threshold, and
associating the selected wireless station with the second radio comprises associating the selected wireless station with the second radio in response to determining that the overall load of the second radio is below the overall load threshold.

52. The non-transitory processor-readable storage medium of claim 44, wherein the stored processor-executable instructions are configured to cause the processor of the access point to perform operations such that:
determining whether the load of the second radio is below the load threshold comprises determining whether an MU load of the second radio is below an MU load threshold, and
associating the selected wireless station with the second radio comprises associating the selected wireless station with the second radio in response to determining that the MU load of the second radio of the access point is below the MU load threshold.

53. The non-transitory processor-readable storage medium of claim 44, wherein the stored processor-executable instructions are configured to cause the processor of the access point to perform operations further comprising:
determining whether an MU data quality metric of the communication link exceeds a data quality threshold in response to determining that the MU physical layer quality of the communication link exceeds the quality threshold; and
associating the selected wireless station with the second radio of the access point in response to determining that the MU data quality metric of the communication link does not exceed the data quality threshold.

54. The non-transitory processor-readable storage medium of claim 53, wherein the stored processor-executable instructions are configured to cause the processor of the access point to perform operations such that associating the selected wireless station with the second radio of the access point in response to determining that the MU data quality metric of the communication link does not exceed the data quality threshold comprises:
determining whether an MU physical layer quality of a second communication link between the second radio and the wireless station exceeds the quality threshold; and
associating the selected wireless station with the second radio in response to determining that the MU physical layer quality exceeds the quality threshold.

55. The non-transitory processor-readable storage medium of claim 54, wherein the stored processor-executable instructions are configured to cause the processor of the access point to perform operations further comprising:
determining whether an overall load of the second radio is below an overall load threshold in response to determining that the MU physical layer quality of the second communication link between the second radio and the wireless station exceeds the quality threshold; and
associating the selected wireless station with the second radio in response to determining that the overall load of the second radio is below the overall load threshold.

56. The non-transitory processor-readable storage medium of claim 55, wherein the stored processor-executable instructions are configured to cause the processor of the access point to perform operations further comprising:
determining whether an MU load of the second radio is below an MU load threshold in response to determining that the overall load of the second radio is below the overall load threshold; and
associating the selected wireless station with the second radio in response to determining that the MU load of the second radio is below the MU load threshold.

57. The non-transitory processor-readable storage medium of claim 53, wherein the stored processor-executable instructions are configured to cause the processor of the access point to perform operations further comprising:
determining whether an MU interference of the communication link is below an MU interference threshold in response to determining that the MU data quality metric of the communication link exceeds the data quality threshold; and
associating the selected wireless station with the second radio of the access point in response to determining that the MU interference of the communication link is not below the MU interference threshold.

58. The non-transitory processor-readable storage medium of claim 57, wherein the stored processor-executable instructions are configured to cause the processor of the access point to perform operations such that associating the selected wireless station with the second radio of the access point in response to determining that the MU interference of the communication link is not below the MU interference threshold comprises:
determining whether an MU physical layer quality of a second communication link between the second radio and the selected wireless station exceeds the quality threshold; and
associating the selected wireless station with the second radio in response to determining that the MU physical layer quality exceeds the quality threshold.

59. The non-transitory processor-readable storage medium of claim 58, wherein the stored processor-executable instructions are configured to cause the processor of the access point to perform operations further comprising
determining whether an overall load of the second radio is below an overall load threshold in response to determining that the MU physical layer quality of the second communication link between the second radio and the selected wireless station exceeds the quality threshold; and
associating the selected wireless station with the second radio in response to determining that the overall load of the second radio is below the overall load threshold.

60. The non-transitory processor-readable storage medium of claim 59, wherein the stored processor-executable instructions are configured to cause the processor of the access point to perform operations further comprising:
determining whether an MU load of the second radio is below an MU load threshold in response to determining that the overall load of the second radio is below the overall load threshold; and
associating the selected wireless station with the second radio in response to determining that the MU load of the second radio is below the MU load threshold.

61. An access point, comprising:
means for determining whether a multi-user (MU) physical layer quality of a communication link between a radio of the access point and a wireless station exceeds a quality threshold in response to receiving at the access point an access request from the wireless station;
means for determining whether a load of the radio of the access point is below a load threshold in response to determining that the MU physical layer quality of the communication link exceeds the quality threshold; and
means for associating the wireless station with the radio of the access point in response to determining that the load of the radio of the access point is below the load threshold.

62. The access point of claim 61,
wherein means for determining whether the load of the radio of the access point is below the load threshold comprises means for determining whether an overall load of the radio is below an overall load threshold, and
wherein means for associating the wireless station with the radio of the access point comprises means for associating the wireless station with the radio in response to determining that the overall load of the radio is below the overall load threshold.

63. The access point of claim 61,
wherein means for determining whether the load of the radio of the access point is below the load threshold comprises means for determining whether an MU load of the radio is below an MU load threshold, and
wherein means for associating the wireless station with the radio of the access point comprises means for associating the wireless station with the radio in response to determining that the MU load of the radio is below the MU load threshold.

64. An access point, comprising:
means for determining whether a load of a first radio of the access point is below a load threshold, wherein one or more wireless stations are associated with the first radio;
means for selecting a wireless station associated with the first radio in response to determining that the load is below the load threshold;
means for determining whether a multi-user (MU) physical layer quality of a communication link between the first radio of the access point and the selected wireless station exceeds a quality threshold; and
means for associating the selected wireless station with a second radio of the access point in response to determining that the MU physical layer quality of the communication link between the first radio of the access point and the selected wireless station does not exceed the quality threshold.

65. The access point of claim 64, wherein means for associating the selected wireless station with the second radio of the access point in response to determining that the MU physical layer quality of the communication link between the first radio of the access point and the wireless station does not exceed the quality threshold comprises:
means for determining whether an MU physical layer quality of a second communication link between the second radio and the wireless station exceeds the quality threshold; and
means for associating the selected wireless station with the second radio in response to determining that the MU physical layer quality exceeds the quality threshold.

66. The access point of claim 65, further comprising:
means for determining whether an overall load of the second radio is below an overall load threshold in response to determining that the MU physical layer quality of the second communication link exceeds the quality threshold; and
means for associating the selected wireless station with the second radio in response to determining that the overall load of the second radio is below the overall load threshold.

67. The access point of claim 66, further comprising:
means for determining whether an MU load of the second radio is below an MU load threshold in response to determining that the overall load of the second radio is below the overall load threshold; and
means for associating the selected wireless station with the second radio in response to determining that the MU load of the second radio is below the MU load threshold.

68. The access point of claim 64, wherein means for determining whether the load of the first radio of the access point is below the load threshold comprises means for determining whether an overall load of the first radio is below an overall load threshold, and
wherein means for associating the selected wireless station with the second radio of the access point comprises:
means for determining whether an MU load of the first radio is greater than an MU load threshold in response to determining that the overall load of the first radio is not below the overall load threshold; and
means for associating the selected wireless station with the second radio of the access point in response to determining that the MU load of the first radio is greater than the MU load threshold.

69. The access point of claim 68, further comprising:
means for determining a contribution of wireless stations associated with the first radio and operating in an MU mode to the overall load of the first radio in response to determining that the MU load of the first radio is not greater than an MU load threshold;
means for determining whether the contribution of the associated wireless stations operating in the MU mode to the overall load of the first radio exceeds a threshold contribution; and
means for associating one of the associated wireless stations with the second radio of the access point in response to determining that the contribution of the associated wireless stations operating in the MU mode to the overall load of the first radio exceeds the threshold contribution.

70. The access point of claim 64, wherein means for determining whether the load of the first radio of the access point is below the load threshold comprises means for determining whether an MU load of the first radio is below an MU load threshold, and
wherein means for associating the selected wireless station with the second radio of the access point comprises:
means for determining whether an MU physical layer quality of a second communication link between the second radio and the selected wireless station exceeds a quality threshold;
means for determining whether a load of the second radio is below a load threshold in response to determining that the MU physical layer quality of the second communication link exceeds the quality threshold; and
means for associating the selected wireless station with the second radio in response to determining that the load of the second radio is below the load threshold.

71. The access point of claim 70,
wherein means for determining whether the load of the second radio is below the load threshold comprises means for determining whether an overall load of the second radio is below an overall load threshold, and
wherein means for associating the selected wireless station with the second radio comprises means for associating the selected wireless station with the second radio in response to determining that the overall load of the second radio is below the overall load threshold.

72. The access point of claim 70
wherein means for determining whether the load of the second radio is below the load threshold comprises means for determining whether an MU load of the second radio is below an MU load threshold, and
wherein means for associating the selected wireless station with the second radio comprises means for associating the selected wireless station with the second radio in response to determining that the MU load of the second radio of the access point is below the MU load threshold.

73. The access point of claim 64, further comprising:
means for determining whether an MU data quality metric of the communication link exceeds a data quality threshold in response to determining that the MU physical layer quality of the communication link exceeds the quality threshold; and
means for associating the selected wireless station with the second radio of the access point in response to determining that the MU data quality metric of the communication link does not exceed the data quality threshold.

74. The access point of claim 73, wherein means for associating the selected wireless station with the second radio of the access point in response to determining that the MU data quality metric of the communication link does not exceed the data quality threshold comprises:
means for determining whether an MU physical layer quality of a second communication link between the second radio and the wireless station exceeds the quality threshold; and
means for associating the selected wireless station with the second radio in response to determining that the MU physical layer quality exceeds the quality threshold.

75. The access point of claim 74, further comprising:
means for determining whether an overall load of the second radio is below an overall load threshold in response to determining that the MU physical layer quality of the second communication link between the second radio and the wireless station exceeds the quality threshold; and
means for associating the selected wireless station with the second radio in response to determining that the overall load of the second radio is below the overall load threshold.

76. The access point of claim 75, further comprising:
means for determining whether an MU load of the second radio is below an MU load threshold in response to determining that the overall load of the second radio is below the overall load threshold; and
means for associating the selected wireless station with the second radio in response to determining that the MU load of the second radio is below the MU load threshold.

77. The access point of claim 73, further comprising:
means for determining whether an MU interference of the communication link is below an MU interference threshold in response to determining that the MU data quality metric of the communication link exceeds the data quality threshold; and
means for associating the selected wireless station with the second radio of the access point in response to determining that the MU interference of the communication link is not below the MU interference threshold.

78. The access point of claim 77, wherein means for associating the selected wireless station with the second radio of the access point in response to determining that the MU interference of the communication link is not below the MU interference threshold comprises:
means for determining whether an MU physical layer quality of a second communication link between the second radio and the selected wireless station exceeds the quality threshold; and
means for associating the selected wireless station with the second radio in response to determining that the MU physical layer quality exceeds the quality threshold.

79. The access point of claim 78, further comprising:
means for determining whether an overall load of the second radio is below an overall load threshold in response to determining that the MU physical layer quality of the second communication link between the second radio and the selected wireless station exceeds the quality threshold; and
means for associating the selected wireless station with the second radio in response to determining that the overall load of the second radio is below the overall load threshold.

80. The access point of claim 79, further comprising:
means for determining whether an MU load of the second radio is below an MU load threshold in response to determining that the overall load of the second radio is below the overall load threshold; and
means for associating the selected wireless station with the second radio in response to determining that the MU load of the second radio is below the MU load threshold.
